(19) United States
(12) Patent Application Publication
(10) Pub. No.: US 2019/0330477 A1
(43) Pub. Date: Oct. 31, 2019

(54) COATING MATERIAL, COATING MATERIAL SET, AND PLUMBING MEMBER

(71) Applicant: LIXIL CORPORATION, Koto-ku, Tokyo (JP)

(72) Inventors: Yasuhiro ITODA, Koto-ku, Tokyo (JP); Hiroshi KAKEHI, Koto-ku, Tokyo (JP); Yoichi WATANABE, Koto-ku, Tokyo (JP)

(73) Assignee: LIXIL CORPORATION, Koto-ku, Tokyo (JP)

(21) Appl. No.: 16/080,830

(22) PCT Filed: Nov. 1, 2016
(86) PCT No.: PCT/JP2016/082451

§ 371 Date: Aug. 29, 2018

(30) Foreign Application Priority Data
Mar. 9, 2016 (JP) 2016-045166

(51) Int. Cl. C09D 5/00; B05D 5/00; B05D 7/02; B05D 7/00; B05D 1/02; C09D 183/04; C09D 7/61; C09D 7/63; B05D 3/00; C09D 133/02

(52) U.S. Cl. CPC C09D 5/002; B05D 5/005; B05D 7/02; B05D 7/546; B05D 1/02; C09D 183/04; B05D 2518/10; C09D 7/63; B05D 3/002; C09D 133/02; B05D 2201/02; B05D 2502/00; C09D 7/61

(57) ABSTRACT

It is an object of the present invention to fix a silane-based coating in a highly durable state on a resinous base. A coating material for a primer fixes a silane-based coating on a resinous base. The coating material contains a polyacrylic acid, and an alkoxysilane having two or more alkoxy groups in its molecule and/or a hydrolysis product thereof. The use of the coating material for a primer of the present invention makes it possible to form a coating for imparting an effect of suppressing slime deposition on the resinous base.

### TECHNICAL FIELD

The present invention relates to a coating material, a coating material set, and a plumbing member.

### BACKGROUND ART

On the surface of a plumbing member such as a drain trap installed in a sink of a system kitchen, a drainage garbage placed on the drain trap, or a drain plate covering an opening of the drainage garbage, slime deposition occurs, which may causes odor to occur. This is due to the fact that dirt components such as food materials and oils and fats adhere and remain, which cause bacteria to grow.

A coating material for plumbing member disclosed in Patent Document 1 has been known. Patent Document 1 proposes an antimicrobial treatment agent containing a specific quaternary ammonium salt and a polycarboxylic acid having a hydrocarbon group having 6 or more carbon atoms and two or more carboxyl groups as a silane-based coating material. Specifically, an antimicrobial treatment agent characterized by the combination of 3-trimethoxysilylpropyloctadecyldimethylammonium chloride and trimesic acid or the like is disclosed. This technique employs a mechanism of fixing a quaternary ammonium salt having strong antimicrobial properties on a plumbing member made of a metal such as stainless steel to suppress bacteria, thereby suppressing the occurrence of slime deposition. The use of the technique makes it possible to form an antimicrobially treated surface excellent also in hot water resistance on the plumbing member.

### CITATIONS LIST

### Patent Literature

Patent Literature 1: Japanese Unexamined Patent Application Publication No. 2015-67657

### SUMMARY OF INVENTION

### Technical Problems

However, the technique makes it possible to fix a silane-based coating to a base made of a metal such as stainless steel or glass or the like, but it makes it difficult to fix the silane-based coating on a base made of a resin or the like, and cannot secure durability.

The present invention has been made in view of the above conventional circumstances, and an object thereof is to fix a silane-based coating on a resinous base, preferably in a highly durable state.

### Solutions to Problems

The present inventors have intensively studied in view of the above-described prior art, and as a result, developed a novel coating material for a primer.

The present inventors found an unexpected fact that the use of the novel coating material allows a silane-based coating to be fixed on a resinous base. The present invention has been made based on this finding.

That is, a first aspect of the present invention is a coating material for a primer which fixes a silane-based coating on a resinous base, the coating material containing: a polymer (A-1) having a repeating unit represented by the following formula (1); and an alkoxysilane having two or more alkoxy groups in its molecule and/or a hydrolysis product (A-2) thereof.

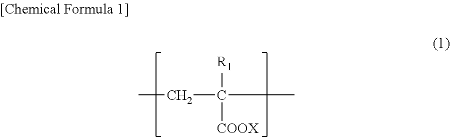

wherein R¹ represents a hydrogen atom or a methyl group, and X represents a hydrogen atom, Na, or K.

A second aspect of the present invention is a coating material set containing: the coating material (A) according to the first aspect; and a coating material (B) containing a quaternary ammonium salt represented by the following formula (2) and/or a hydrolysis product (B-1) thereof.

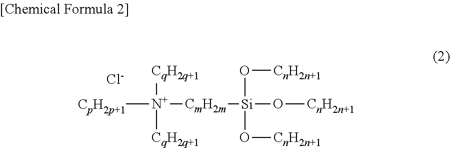

wherein: n represents an integer of 1 to 4; m represents an integer of 1 to 10; p represents an integer of 10 to 22; and q represents an integer of 1 to 3.

A third aspect of the present invention is the coating material set according to the second aspect, wherein the coating material (B) contains an organic acid or an inorganic acid.

A fourth aspect of the present invention is the coating material set according to the second or third aspect, wherein the coating material set is used for antimicrobial coating.

A fifth aspect of the present invention is the coating material set according to any one of the second to fourth aspects, wherein the resinous base is at least one selected from the group consisting of a polypropylene resin, an ABS resin, a POM resin, a vinyl chloride resin, an acrylic resin, a polycarbonate resin, a polyethylene resin, an unsaturated polyester-based thermosetting resin, and an acrylic thermosetting resin.

A sixth aspect of the present invention is the coating material set according to any one of the second to fifth aspects, wherein the alkoxysilane and/or the hydrolysis product (A-2) thereof have/has four functional groups.

A seventh aspect of the present invention is a plumbing member coated with the coating material set according to any one of the second to sixth aspects. Advantageous Effects of Invention

A coating material for a primer of the present invention allows a silane-based coating to be fixed on a resinous base.

The coating material set of the present invention provides a plumbing member in which a silane-based coating is fixed on a resinous base.

The plumbing member of the present invention has antimicrobial properties, and is also excellent in hot water resistance.

### BRIEF DESCRIPTION OF DRAWINGS

FIG. 1 shows a spectrum obtained by Fourier transform infrared spectroscopy (FT-IR) as an example of a coating for overcoating containing a quaternary ammonium salt and trimesic acid.

FIG. 2 shows a preparing process of a resin-treated article.

FIG. 3 is a graph showing the results of an actual exposure test.

FIG. 4 is a photograph of one of Examples of the actual exposure test which has the score of “1” and is evaluated as “almost no slime deposition adheres”.

FIG. 5 is a photograph of one of Comparative Examples of the actual exposure test which has the score of “3” and is evaluated as “firm slime deposition partially adheres”.

### DESCRIPTION OF EMBODIMENTS

Preferred embodiments of the present invention will be described.

### [1] Coating Material for Primer (A)

A coating material (A) of the present invention is a coating material for a primer which fixes a silane-based coating on a resinous base. By the coating material, a primer coating is formed.

The coating material (A) contains a polymer (A-1), and an alkoxysilane having two or more alkoxy groups in its molecule and/or a hydrolysis product (A-2) thereof.

First, the silane-based coating to be fixed by the coating material (A) of the present invention will be described.

### [1-1] Silane-Based Coating Material

A coating material for forming a coating to be fixed on the resinous base as the coating material (A) of the present invention is not particularly limited, but a fluorine-based silane coating material, a silicone-based silane coating material, and a quaternary ammonium salt-based silane coating material are suitably exemplified. The coating material (A) of the present invention is suitably used for a primer for these silane-based coating materials.

The fluorine-based silane coating material is not particularly limited as long as it is a silane coating material having a fluorine atom in its molecule, but suitable examples thereof include perfluoropolyether-modified aminosilane and a partially hydrolyzed condensate thereof. For example, a fluorine-based silane coating material described in Japanese Unexamined Patent Application Publication No. 11-29585 is exemplified.

Specifically, a compound represented by the following formula is suitably used.

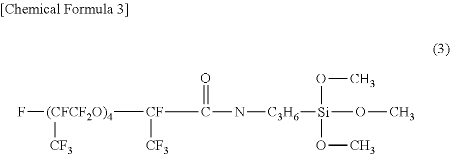

Suitable examples of the silicone-based silane coating material include a silane-modified silicone, and particularly preferred is a both-terminal silane-modified silicone.

Specifically, a compound represented by the following formula is suitably used.

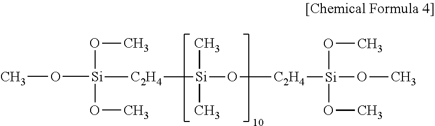

The quaternary ammonium salt-based silane coating material is not particularly limited, but a coating material (B) to be described in detail below is particularly preferable.

### [1-2] Polymer (A-1)

The polymer (A-1) has a repeating unit represented by the following formula (1).

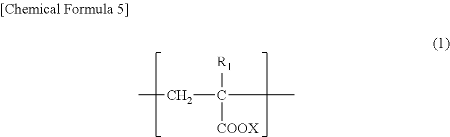

wherein R¹ represents a hydrogen atom or a methyl group, and X represents a hydrogen atom, Na, or K.

Examples of the polymer (A-1) include polyacrylic acid, polymethacrylic acid, copolymers of acrylic acid and methacrylic acid, and salts thereof. Herein, the polyacrylic acid and the polymethacrylic acid are collectively referred to as poly(meth)acrylic acid.

The polymer (A-1) may be a partially neutralized product of poly(meth)acrylic acid. Such a partially neutralized product of poly(meth)acrylic acid is obtained by appropriately neutralizing poly(meth)acrylic acid with an appropriate alkali, for example, an alkali metal compound such as sodium hydroxide or potassium hydroxide.

The polymer (A-1) may further contain a structural unit other than the above formula (1) as long as the effect of the present invention is not impaired. For example, monomer units other than a (meth)acrylic monomer unit such as a styrene-based monomer unit may be contained.

One kind of the polymer (A-1) may be used alone, or two or more kinds thereof may be used in combination.

The degree of polymerization of the polymer (A-1) is not particularly limited. The degree of polymerization is preferably 100 to 10000, more preferably 200 to 5000, and particularly preferably 300 to 1000. Among these, the use of polyacrylic acid having a degree of polymerization of 300 to 1000 particularly provides an excellent effect as a primer.

As described above, various polymers can be employed as the polymer (A-1), and among these, polyacrylic acid having a degree of polymerization of 300 to 1000 is particularly preferable.

### [1-3] Alkoxysilane Having Two or More Alkoxy Groups in its Molecule and/or Hydrolysis Product (A-2) Thereof

In the present invention, as the alkoxysilane having two or more alkoxy groups in its molecule, di- to tetrafunctional alkoxysilanes can be widely used.

The hydrolysis product of the alkoxysilane is obtained by adding water to a compound of the alkoxysilane to convert some or all of alkoxy groups to hydroxy groups.

Furthermore, following the hydrolysis of the alkoxy groups, these may be partially subjected to a condensation reaction. By this condensation reaction, hydrolysis products are tightly bound by covalent bonds.

As a bifunctional or higher alkoxysilane, a compound represented by the following formula can be suitably used.

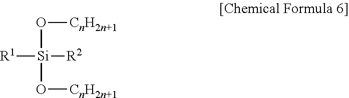

In the above general formula, n represents an integer of 1 to 4.

In the above general formula, R¹ and R² each independently represent OCₘH₂ₘ₊₁ (m represents an integer of 1 to 4) or an arbitrary organic chain. Examples of OCₘH₂ₘ₊₁ or arbitrary organic chain include a linear or branched alkyl group having 1 to 18 carbon atoms, a monovalent hydrocarbon group having 3 to 8 carbon atoms and having an alicyclic skeleton, and a linear or branched alkoxyl groups having 1 to 4 carbon atoms. R¹ and R² may be the same as or different from each other.

When the substituents R¹ and R² constituting the above general formula are linear or branched alkyl groups having 1 to 18 carbon atoms, they may be linear or branched. Examples thereof include a methyl group, an ethyl group, a n-propyl group, an i-propyl group, an n-butyl group, an i-butyl group, a sec-butyl group, a t-butyl group, an n-pentyl group, an n-hexyl group, an n-heptyl group, an n-octyl group, a 2-ethylhexyl group, an nonyl group, a decyl group, and a dodecyl group.

When the substituents R¹ and R² are monovalent hydrocarbon groups having 3 to 8 carbon atoms and having an alicyclic skeleton, examples thereof include a cyclopropyl group, a cyclobutyl group, a cyclopentyl group, a cycloheptyl group, a cyclooctyl group, and a norbornene group.

When the sub stituents R¹ and R² are linear or branched alkoxyl groups having 1 to 18 carbon atoms, examples thereof include a methoxy group, an ethoxy group, a hydroxyethoxy group, a propoxy group, a hydroxypropoxy group, and a butoxy group.

In the present invention, it is preferable that the alkoxysilane having two or more alkoxy groups in its molecule and/or the hydrolysis product thereof have four functional groups. This is because the four functional groups effectively exhibit a function as a primer.

The alkoxysilane having four functional groups is not particularly limited, and a compound represented by the following formula can be suitably used.

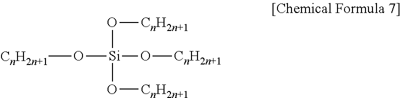

In the above general formula, n represents an integer of 1 to 4.

Specific examples of the alkoxysilane to be used include tetraalkoxysilanes such as tetrabutoxysilane, tetramethoxysilane, tetraethoxysilane, tetrapropoxysilane and tetraisopropoxysilane; trialkoxysilanes such as methyltrimethoxysilane, methyltriethoxysilane, methyltripropoxysilane, methyltributoxysilane, ethyltrimethoxysilane, ethyltriethoxysilane, n-propyltrimethoxysilane, n-propyltriethoxysilane, isopropyltrimethoxysilane, isopropyltriethoxysilane, vinyltrimethoxysilane, vinyltriethoxysilane, 3-glycidoxypropyltrimethoxysilane, 3-glycidoxypropyltriethoxysilane, 3-mercaptopropyltrimethoxysilane, 3-mercaptopropyltriethoxysilane, phenyltrimethoxysilane, phenyltriethoxysilane, 3,4-epoxycyclohexy ethyltrimethoxysilane and 3,4-epoxycyclohexylethyltrimethoxysilane; and dialkoxysilanes such as dimethyldimethoxysilane, dimethyldiethoxysilane, diethyldimethoxysilane and diethyldiethoxysilane. Of these, tetrabutoxysilane is preferably used in the present invention from the viewpoint of reactivity.

One kind of the alkoxysilane and/or the hydrolysis product thereof may be used alone, or two or more kinds thereof may be used in combination.

### [1-4] Solvent and Blending Ratio of Coating Material (A)

The solvent of the coating material (A) is not particularly limited. For example, alcohol can be used. The alcohol is not particularly limited. Examples thereof include 1-butanol, 2-butanol, methanol, ethanol, 1-propanol, 2-propanol, 2-methyl-1-propanol, 2-methyl-2-propanol, pentanol, hexanol, heptanol, octanol, nonanol, decanol, trans-3-hexenol, linalool, geraniol, allyl alcohol, and benzyl alcohol.

Other solvents can also be used. Examples of the other solvents include water and organic solvents such as linear hydrocarbon-based compounds (such as hexane, heptane, octane, decane and paraffin), aromatic hydrocarbon-based compounds (such as benzene, toluene, xylene, ethylbenzene, cumene, cymene and styrene), terpene-based hydrocarbon compounds (such as limonene, menthane, pinene and dipentene), halogenated hydrocarbon compounds (such as chloroform, carbon tetrachloride, trichloroethane, tetrachloroethane, trichlorethylene, tetrachlorethylene, chlorobenzene, dichlorobenzene, trichlorobenzene, ethyl bromide, propyl bromide, bromobenzene, dibromobenzene and fluorobenzene), phenolic compounds (such as phenol, cresol and xylenol), ether-based compounds (such as diethyl ether, dipropyl ether, dibutyl ether, ethylvinyl ether, anisole, phenetol, dibenzyl ether, dioxane, trioxane, flan, cineole, diethylene glycol diethyl ether and acetal), ketone compounds (such as acetone, methyl ethyl ketone, 2-hexanone and cyclohexanone), fatty acid-based compounds (such as formic acid, acetic acid, propionic acid, butyric acid, valeric acid, oleic acid and acetic anhydride), ester-based compounds (such as formic acid ester, acetic acid ester, propionic acid ester, butyric acid ester, valeric acid ester, heptylic acid ester, heptenecarboxylic acid ester, octene carboxylic acid ester, lauric acid ester, myristic acid ester, benzoic acid ester, phenylacetic acid ester, cinnamic acid ester, phthalic acid ester, salicylic acid ester, anisic acid ester, anthranilic acid ester, methyl anthranilic acid ester and chrysanthemic acid ester), nitrogen compounds (such as nitromethane, nitroethane, nitrobenzene, acetonitrile, methylamine, dimethylamine, allylamine, aniline, N,N-dimethyl aniline, toluidine, pyridine, quinoline, ethylenediamine, formamide, pyrrolidone and ε-caprolactam), sulfur compounds (such as carbon disulfide, dimethyl sulfide and thiophene), glycol-based compounds (such as ethylene glycol and propylene glycol), glycol ether-based compounds (such as 2-methoxyethanol, 2-ethoxyethanol, 2-phenoxyethanol, 3-methyl-3-methoxybutanol and diethylene glycol monomethyl ether), sesame oil, linoleic oil, and salad oil.

One kind of the solvent may be used, or two or more kinds thereof may be used in combination.

The blending amount of the polymer (A-1) is not particularly limited. For example, when the total amount of the coating material (A) is 100 parts by mass, the blending amount is preferably 0.05 to 10 parts by mass, more preferably 0.1 to 5 parts by mass, and particularly preferably 0.1 to 3 parts by mass.

The blending amount of the alkoxysilane and/or hydrolysis product thereof is not particularly limited. For example, when the amount of the coating material (A) is 100 parts by mass, the blending amount is preferably 0.1 to 20 parts by mass, more preferably 0.5 to 15 parts by mass, and particularly preferably 1.0 to 10 parts by mass.

### [1-5] Application and Curing of Coating Material (A)

A method for applying the coating material for a primer (A) on the resinous base is not particularly limited, and can be selected according to the properties, viscosity and application amount of the coating material (A). The method can be selected according to known methods such as spray application, dip application, roller application, and curtain flow coater application. Among these, the spray application is suitably used since it can provide uniform application on the resinous base.

The application amount (wet) of the coating material (A) is not particularly limited, and can be selected according to the properties and viscosity of the coating material (A). For example, the application amount is preferably 3 to 100 g/m², more preferably 3 to 80 g/m², and still more preferably 5 to 50 g/m².

The coating material (A) is usually cured at room temperature or by heating. The heating temperature is not particularly limited, and can be selected according to the properties, viscosity and application amount of the coating material (A). For example, the heating temperature is preferably room temperature (15 to 25° C.) to 200° C., more preferably 25 to 120° C., and still more preferably 50 to 90° C.

The heating time is not particularly limited, and can be selected according to the properties, viscosity and application amount of the coating material (A). For example, the heating time is preferably 15 minutes to 120 minutes, more preferably 20 minutes to 100 minutes, and still more preferably 20 to 80 minutes.

### [2] Coating Material (B)

The coating material (B) contains a quaternary ammonium salt and/or a hydrolysis product (B-1) thereof. By the coating material (B), a functional coating having a function such as antimicrobial properties is formed on a primer coating.

### [2-1] Quaternary Ammonium Salt and/or Hydrolysis Product (B-1) Thereof

The quaternary ammonium salt and/or the hydrolysis product thereof of the present invention is represented by the following formula (2).

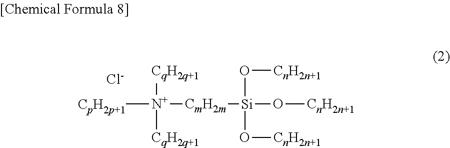

wherein: n represents an integer of 1 to 4; m represents an integer of 1 to 10; p represents an integer of 10 to 22; and q represents an integer of 1 to 3.

In the present invention, preferable compounds among the compounds represented by the above (2) will be listed below. This compound is a compound in which n=1, m=3, p=18, and q=1 are set in the compound of (2), and is 3-trimethoxysilylpropyloctadecyldimethylammonium chloride. This compound is preferable in view of antimicrobial properties and safety.

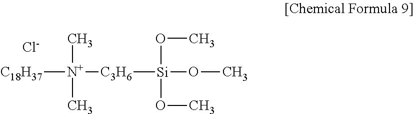

### [2-2] Organic Acid or Inorganic Acid

It is preferable that the coating material (B) contain an organic acid or an inorganic acid. This is because the incorporation of the organic acid or inorganic acid in the coating material (B) causes the acid to transfer from the functional coating for overcoating to the undercoated primer coating to promote the curing reaction of the primer coating.

The organic acid is not particularly limited, and a wide variety of organic acids can be used. Examples of the organic acid include organic acids such as trimesic acid (1,3,5 benzenetricarboxylic acid), citric acid, formic acid, acetic acid, glyoxylic acid, pyruvic acid, lactic acid, mandelic acid, vinylacetic acid, 3-hydroxybutyric acid, oxalic acid, maleic acid, malonic acid, methylmalonic acid, dimethylmalonic acid, phthalic acid, tartaric acid, fumaric acid, malic acid, succinic acid, glutaric acid, oxaloacetic acid, hemimellitic acid, trimellitic acid, mellitic acid, isocitric acid, aconitic acid, oxalosuccinic acid, propionic acid, butyric acid, isobutyric acid, valeric acid, isovaleric acid, pivalic acid, caproic acid, octanoic acid, adipic acid, pimelic acid, suberic acid, azelaic acid, sebacic acid, acrylic acid, propiolic acid, methacrylic acid, crotonic acid, isocrotonic acid, benzoic acid, cinnamic acid, isophthalic acid, terephthalic acid, furancarboxylic acid, thiophene carboxylic acid, nicotinic acid, isonicotinic acid, glycolic acid, salicylic acid, creosote acid, vanillic acid, siric acid, pyrocatechuic acid, resorcylic acid, gentisic acid, procatechuic acid, orcerinic acid, gallic acid, tartronic acid, leucic acid, mevalonic acid, pantoic acid, ricinoleic acid, ricinelaidic acid, cerebronic acid, citramalic acid, quinic acid, shikimic acid, mandelic acid, benzylic acid, atrolactic acid, melilotic acid, floretic acid, coumaric acid, umbellic acid, caffeic acid, ferulic acid, isoferulic acid and sinapinic acid, and acid anhydrides of organic acids such as maleic anhydride, propionic anhydride, succinic anhydride and phthalic anhydride. When the organic acid is used, trimesic acid and citric acid are preferred. One kind thereof may be used alone, or two or more kinds thereof may be used in combination.

Examples of the inorganic acid include divalent acids such as hydrochloric acid, sulfuric acid, nitric acid, chromic acid, carbonic acid, molybdic acid, hydrogen sulfide, sulfurous acid, thiosulfuric acid, selenic acid, telluric acid, tellurous acid, tungstic acid and phosphoric acid, trivalent acid such as phosphoric acid, phosphomolybdic acid, phosphotungstic acid and vanadic acid, and tetravalent or more acids such as silicomolybdic acid, silicotungstic acid, pyrophosphoric acid and tripolyphosphoric acid. When the inorganic acid is used, hydrochloric acid and sulfuric acid are preferred. One kind thereof may be used alone, or two or more kinds thereof may be used in combination.

### [2-3] Solvent and Blending Ratio of Coating Material (B)

The solvent of the coating material (B) is not particularly limited. For example, a mixed solvent of alcohol and water can be used. The alcohol is not particularly limited. Examples thereof include isopropyl alcohol (2-propanol), methanol, ethanol, 1-propanol, 1-butanol, 2-butanol, 2-methyl-1-propanol, 2-methyl-2-propanol, pentanol, hexanol, heptanol, octanol, nonanol, decanol, trans-3-hexenol, linalool, geraniol, allyl alcohol and benzyl alcohol.

Other solvents can also be used. Examples of the other solvents include water and organic solvents such as linear hydrocarbon-based compounds (such as hexane, heptane, octane, decane and paraffin), aromatic hydrocarbon-based compounds (such as benzene, toluene, xylene, ethylbenzene, cumene, cymene and styrene), terpene-based hydrocarbon compounds (such as limonene, menthane, pinene and dipentene), halogenated hydrocarbon compounds (such as chloroform, carbon tetrachloride, trichloroethane, tetrachloroethane, trichlorethylene, tetrachlorethylene, chlorobenzene, dichlorobenzene, trichlorobenzene, ethyl bromide, propyl bromide, bromobenzene, dibromobenzene and fluorobenzene), phenolic compounds (such as phenol, cresol and xylenol), ether-based compounds (such as diethyl ether, dipropyl ether, dibutyl ether, ethylvinyl ether, anisole, phenetol, dibenzyl ether, dioxane, trioxane, flan, cineole, diethylene glycol diethyl ether and acetal), ketone compounds (such as acetone, methyl ethyl ketone, 2-hexanone and cyclohexanone), fatty acid-based compounds (such as formic acid, acetic acid, propionic acid, butyric acid, valeric acid, oleic acid and acetic anhydride), ester-based compounds (such as formic acid ester, acetic acid ester, propionic acid ester, butyric acid ester, valeric acid ester, heptylic acid ester, heptenecarboxylic acid ester, octene carboxylic acid ester, lauric acid ester, myristic acid ester, benzoic acid ester, phenylacetic acid ester, cinnamic acid ester, phthalic acid ester, salicylic acid ester, anisic acid ester, anthranilic acid ester, methyl anthranilic acid ester and chrysanthemic acid ester), nitrogen compounds (such as nitromethane, nitroethane, nitrobenzene, acetonitrile, methylamine, dimethylamine, allylamine, aniline, N,N-dimethyl aniline, toluidine, pyridine, quinoline, ethylenediamine, formamide, pyrrolidone and ε-caprolactam), sulfur compounds (such as carbon disulfide, dimethyl sulfide and thiophene), glycol-based compounds (such as ethylene glycol and propylene glycol), glycol ether-based compounds (such as 2-methoxyethanol, 2-ethoxyethanol, 2-phenoxyethanol, 3-methyl-3-methoxybutanol and diethylene glycol monomethyl ether), sesame oil, linoleic oil, and salad oil.

One kind of the solvent may be used, or two or more kinds thereof may be used in combination.

When the mixed solvent of alcohol and water is used as the solvent, the ratio of the amount of the alcohol to the amount of the water is not particularly limited.

The mixing ratio (mass ratio) of alcohol and water is preferably 0.1:99.9 to 99:1, more preferably 10:90 to 95:5, and particularly preferably 40:60 to 90:10 in alcohol:water. The amount of the mixed solvent is preferably 50 to 99 parts by mass, more preferably 70 to 99 parts by mass, and particularly preferably 90 to 97 parts by mass when the total amount of the coating material (B) is 100 parts by mass.

The blending amount of the quaternary ammonium salt and/or the hydrolysis product thereof (B-1) is not particularly limited. For example, when the total amount of the coating material (B) is 100 parts by mass, the blending amount is preferably 0.1 to 20 parts by mass, more preferably 0.1 to 15 parts by mass, and particularly preferably 0.1 to 8 parts by mass.

The blending amount of the organic acid or inorganic acid is not particularly limited. For example, when the total amount of the coating material (B) is 100 parts by mass, the blending amount is preferably 0.2 to 10 parts by mass, more preferably 0.2 to 5 parts by mass, and particularly preferably 0.2 to 2 parts by mass.

### [2-4] Application and Curing of Coating Material (B)

A method for applying the coating material (B) onto the primer-treated resinous base is not particularly limited, and can be selected according to the properties, viscosity and application amount of the coating material (B). The method can be selected according to known methods such as spray application, dip application, roller application, and curtain flow coater application. Among these, the spray application is suitably used since it can provide uniform application on the resinous base.

The application amount (wet) of the coating material (B) is not particularly limited, and can be selected according to the properties and viscosity of the coating material (B). For example, the application amount is preferably 3 to 400 g/m², more preferably 3 to 300 g/m², and still more preferably 3 to 150 g/m².

The coating material (B) is usually cured at room temperature or by heating. The heating temperature is not particularly limited, and can be selected according to the properties, viscosity and application amount of the coating material (B). For example, the heating temperature is preferably room temperature (15 to 25° C.) to 200° C., more preferably 25 to 120° C., and still more preferably 50 to 90° C.

A heating time is not particularly limited, and can be selected according to the properties, viscosity and application amount of the coating material (B). For example, the heating time is preferably 15 minutes to 120 minutes, more preferably 20 minutes to 100 minutes, and still more preferably 20 to 80 minutes.

### [3] Coating Material Set

The coating material set of the present invention contains a coating material (A) and a coating material (B). The application of the coating material set is not particularly limited, and the coating material set can be suitably used for antimicrobial coating.

The resinous base for which the coating material set of the present invention is used is not particularly limited. Examples of the resin constituting the resinous base include olefin-based resins such as polypropylene (PP), low density polyethylene (LDPE) and high density polyethylene (HDPE), ABS resins, styrene resins such as a styrene-acrylonitrile copolymer (SAN resin) and an acrylonitrile-chlorinated polyethylene-styrene copolymer (ACS), polyacetal (POM) resins such as a polyoxymethylene homopolymer, vinyl chloride-based resins such as polyvinyl chloride and polyvinylidene chloride, vinyl chloride copolymer resins such as an ethylene vinyl chloride vinyl acetate copolymer and an ethylene vinyl chloride copolymer, acrylic resins such as polymethyl methacrylate (PMMA), polycarbonate-based resins such as polycarbonate (PC) and modified polycarbonate, rubber unreinforced styrene-based resins such as polystyrene, high impact polystyrene and medium impact polystyrene, polyester-based resins such as polyethylene terephthalate (PETP, PET) and polybutylene terephthalate (PBTP, PBT), polyamide-based resins such as polyamide 66, polyamide 6 and polyamide 46, a polyoxymethylene copolymer, other engineering resins, super engineering resins, for example, cellulose derivatives such as polyethersulfone (PES), polyetherimide (PEI), thermoplastic polyimide (TPI), polyetherketone (PEK), polyetheretherketone (PEEK), polyphenylene sulfide (PSU), cellulose acetate (CA), cellulose acetate butyrate (CAB) and ethyl cellulose (EC), and thermosetting resins such as unsaturated polyester-based, acrylic, vinyl ester-based, urethane-based and epoxy-based thermosetting resins. These resins are not limited to the resin simple substance. To the resins, additives such as an organic pigment, an inorganic pigment, a flame retardant, an antioxidant, an ultraviolet absorber, a lubricant and an antistatic agent, and fillers such as organic and inorganic aggregates, and a glass fiber may be added.

In the present invention, preferred is at least one selected from the group consisting of a polypropylene resin, an ABS resin, a POM resin, a vinyl chloride resin, an acrylic resin, a polycarbonate resin, a polyethylene resin, an unsaturated polyester-based thermosetting resin and an acrylic thermosetting resin. A fiber reinforced plastic (FRP) in which a fiber and an aggregate are added to a thermosetting resin is also suitably used.

To the resinous base using these resins, the functional coating can be firmly fixed by the present invention.

### [4] Plumbing Member

A plumbing member coated with the coating material set of the present invention is not particularly limited. The plumbing member can be widely applied to members equipped to a place around water supply and drainage. Suitable examples of the plumbing member include a bathroom hair catcher, a bathroom floor of a unit bath or the like, a drain trap and drain plate of the bathroom floor, a drain tap of a bathtub, a drain trap of a sink of a system kitchen or the like, a drain waste basket, a drain plate, a washbowl of a bathroom vanity, a drain trap of the washbowl, and a drain plug.

### [5] Background and Action Mechanism of Present Invention

Herein, the background and estimated action mechanism of the present invention will be described. In the following description, a quaternary ammonium salt-based silane coating material will be described as an example of the silane-based coating material, but the same applies to other silane-based coating materials.

Prior to the present invention, a quaternary ammonium salt-based silane coating has been fixed on a metal base such as stainless steel as described below. In this case, a hydroxyl group (—OH) on a stainless steel surface and a hydroxyl group (—OH) of the quaternary ammonium salt have been subjected to dehydration polymerization to form a covalent bond.

On the other hand, in the case of a resinous base made of a polypropylene resin (PP) or the like, a quaternary ammonium salt-based silane coating could not be fixed. This is because no functional group which reacts with the hydroxyl group (—OH) of the quaternary ammonium salt is contained in the polypropylene resin (PP) as described below, which cannot provide bond formation.

Under these circumstances, the present inventors obtained an idea of interposing a primer between a silane-based coating and a resinous base as shown in a schematic diagram to be described below, to fix the silane-based coating to the resinous base.

That is, the present inventors considered that the primer contains a compound having an intermolecular force acting on a resinous base having no reactive group and a compound capable of being chemically bound to a silane-based coating material, which allows the silane-based coating material to be fixed on the resinous base.

As a suitable example of the present invention, in practice, a PP base as the resinous base, and a coating material containing polyacrylic acid (polyflow WS manufactured by Kyoeisha Chemical Co., Ltd., containing an active ingredient of 40% as polyacrylic acid) and tetrabutoxysilane as the coating material for a primer were used for experiment. A coating material containing silane-modified quaternary ammonium salt (3-trimethoxysilylpropyloctadecyldimethylammonium chloride, trade name: AEM 5700, manufactured by Microban, containing an active ingredient of about 40%) and trimesic acid was used for overcoating. The silane coating was firmly fixed on the resinous base. The action mechanism of the coating material for a primer is estimated as follows.

The polyacrylic acid in the primer exerts an intermolecular force on the PP base having no reactive group. The carboxyl group (—COOH) of the polyacrylic acid forms a hydrogen bond with a hydroxyl group (—OH) derived from tetrabutoxysilane. The hydroxyl group (—OH) derived from tetrabutoxysilane causes a condensation reaction with another hydroxyl group (—OH) derived from tetrabutoxysilane to form a covalent bond. Furthermore, the hydroxyl group (—OH) derived from tetrabutoxysilane causes dehydration condensation with the hydroxyl group (—OH) of the quaternary ammonium salt to form a covalent bond.

Trimesic acid forms a hydrogen bond with the hydroxyl group (—OH) derived from tetrabutoxysilane and the hydroxyl group (—OH) of a quaternary ammonium salt.

These intermolecular forces, covalent bonds and hydrogen bonds are inferred to cause the silane coating to be firmly fixed on the resinous base via the primer.

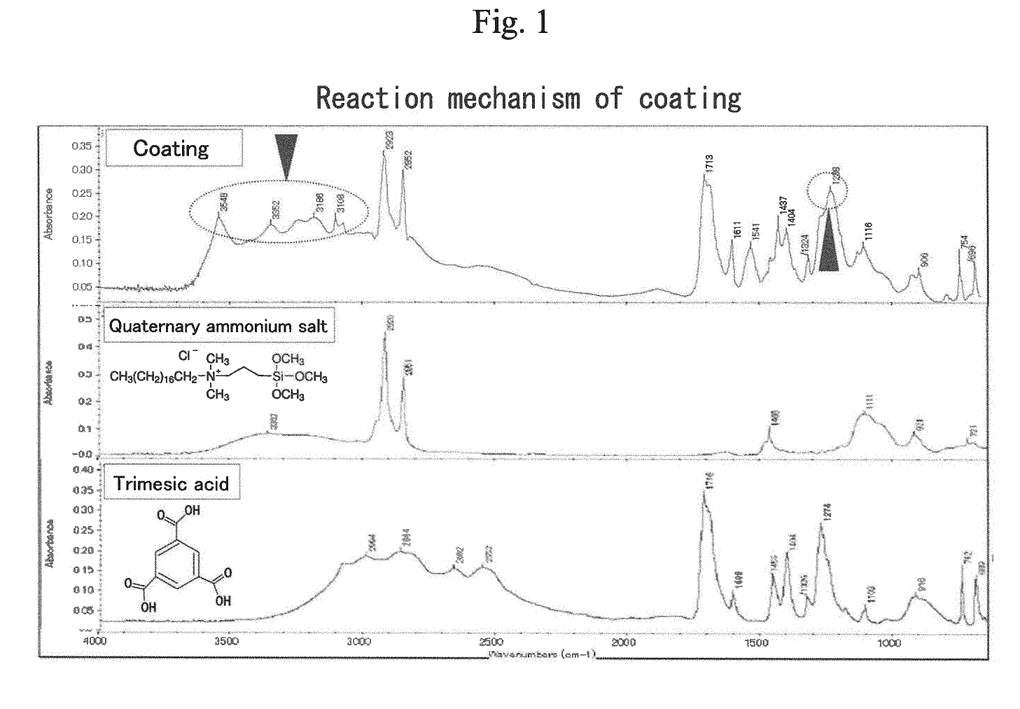

The spectrum provided by Fourier transform infrared spectroscopy (FT-IR) was observed for the coating for overcoating containing a quaternary ammonium salt and trimesic acid. The results are shown in FIG. 1. Here, the quaternary ammonium salt simple substance, the trimesic acid simple substance, and the coating are compared. In the coating, new peaks different from those of the quaternary ammonium salt simple substance and the trimesic acid simple substance were observed at 3548 cm⁻¹, 3352 cm⁻¹, 3186 cm⁻¹, and 3108 cm⁻¹. This is considered to suggest the intermolecular hydrogen bond and intramolecular hydrogen bond of the quaternary ammonium salt and trimesic acid.

The new peak observed at 1238 cm⁻¹ is considered to suggest the intermolecular hydrogen bond of the trimesic acid.

This spectrum was taken into account in order to infer the action mechanism of the coating for a primer.

### EXAMPLES

Hereinafter, the present invention will be more specifically described with reference to Examples.

### 1. Effect of Primer on Various Resin Materials

### Experimental Examples 1 to 10

### [1] Types of Bases

As the base, there were used a polypropylene resin (PP), an ABS resin (ABS), a POM resin (POM), a vinyl chloride resin (PVC), an acrylic resin (acrylic), a polycarbonate resin (polycarbonate), a polyethylene resin (PE), an unsaturated polyester-based thermosetting resin, an acrylic thermosetting resin, and stainless steel (SUS 304).

### [2] Coating Treatment

A coating treatment was performed as follows.

### [2-1] Primer Preparation (Preparation of Coating Material (A))

The primer preparation is shown in Table 1. Tetrabutoxysilane and polyacrylic acid were added in this order to a predetermined amount of solvent, followed by stirring for 1 hour with a magnetic stirrer.

TABLE 1
Preparation of primer (in case of total amount of 100 g)

| | | | | | Active |
|---|---|---|---|---|---|
| | | Manufacture | Part number | Addition | ingredient |
| | Component | name | or part name | amount (g) | amount (g) |
| Component | Tetrabutoxysilane | Tokyo | T1126 | 5.00 | 5.00 |
| | | Chemical | | | |
| | | Industry | | | |
| | | Co., Ltd. | | | |
| Additive | Polyacrylic acid | Kyoeisha | Polyflow | 1.00 | 0.40 |
| | | Chemical | WS | | |
| | | Co., Ltd. | | | |
| Solvent | 1-butanol | Wako Pure | 024-03327 | 94.00 | — |
| | | Chemical | | | |
| | | Industries, | | | |
| | | Ltd. | | | |

### [2-2] Preparation of Quaternary Ammonium Salt-Based Silane Coating Material

The preparation of the quaternary ammonium salt-based silane coating material is shown in Table 2. The preparation procedure is as follows. As shown in the preparation Table below, IPA (isopropyl alcohol) and trimesic acid were mixed with a magnetic stirrer until the trimesic acid was dissolved in the IPA. On the other hand, quaternary ammonium salt-containing silane shown below and pure water were mixed with a magnetic stirrer until the quaternary ammonium salt-containing silane was dissolved in the pure water. From the two solutions thus prepared, one solution was provided, and the solution was mixed for 10 minutes to obtain a coating material.

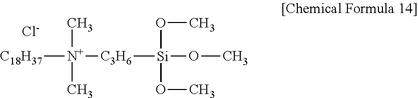

TABLE 2
Preparation of quaternary ammonium salt-based silane coating (in case
of total amount of 100 g)

| | | | Part | | Active |
|---|---|---|---|---|---|
| | | | number | Addition | ingredient |
| | | Manufacture | or part | amount | amount |
| | Component | name | name | (g) | (g) |
| Solid | Quaternary | Microban | AEM | 4.00 | 1.60 |
| content | ammonium | | 5700 | | |
| | salt | | | | |
| | Trimesic | Tokyo | B0043 | 1.25 | 1.25 |
| | acid | Chemical | | | |
| | | Industry | | | |
| | | Co., Ltd. | | | |
| Solvent | Pure water | — | — | 18.95 | — |
| | IPA | Wako Pure | 32435-80 | 75.80 | — |
| | | Chemical | | | |
| | | Industries, | | | |
| | | Ltd. | | | |

### [2-3] Treatment Step (Preparation of Sample)

Treatment steps of various bases will be described below.

1) Various bases were dipped in IPA for 5 minutes for a degreasing treatment. Each of the bases was dried at room temperature, and a primer was then spray-applied so that the WET of the primer was set to 10 g/m². Each of the bases was set at room temperature for 5 minutes, and then heated and cured at 60° C. for 60 minutes to obtain a primer-treated sample.

2) A quaternary ammonium salt-based silane coating was spray-applied on the sample of 1) so that the WET of the coating was set to 60 g/m², and heated and cured at 60° C. for 30 minutes, to obtain a quaternary ammonium salt treated sample.

There were prepared two kinds of samples: a sample obtained by subjecting the various bases to a primer treatment and a quaternary ammonium salt treatment, and a sample obtained by subjecting the bases to only a quaternary ammonium salt treatment. However, even the sample subjected only to the quaternary ammonium salt treatment is subjected to a degreasing treatment.

### [2-4] Endurance Test

Using a constant temperature water bath, the samples were immersed in water at 70° C. for 19 hours (hot water test).

### [2-5] Evaluation Method

A BPB solution (to be described in detail below) was dropped onto the sample after the endurance test, to visually determine the wettability of the appearance. A coating for suppressing slime deposition is colored by the BPB solution.

BPB solution . . . 0.4 g/L bromophenol blue (Kanto Kagaku)

pH range: 3.0 (yellow) to 4.6 (blue-purple)

### [2-6] Evaluation

The evaluation results of Experimental Examples 1 to 10 are shown in Table 3. The evaluation is as follows. Among Experimental Examples 1 to 9, “Pr” represents Examples, and Experiment Example 10 represents Reference Example. In Table 3, “Pr” represents a treatment using a primer (coating material (A)), and “no Pr” represents no treatment using a primer (coating material (A)).

(Initial)

◯=good wetting

x=poor wetting

(After Endurance Test)

◯=coating remaining amount: 100%

Δ=coating remaining amount: 70% or more

x=coating remaining amount: less than 70%

### [2-7] Evaluation Results

TABLE 3

| | | | | After endurance | |
|---|---|---|---|---|---|
| | | Initial | | (hot water) | |
| | Types of bases | No Pr | Pr | No Pr | Pr |
| Experimental | PP | x | ∘ | x | ∘ |
| Example 1 | | | | | |
| Experimental | ABS | x | ∘ | x | ∘ |
| Example 2 | | | | | |
| Experimental | POM | x | ∘ | x | ∘ |
| Example 3 | | | | | |
| Experimental | PVC | x | ∘ | x | ∘ |
| Example 4 | | | | | |
| Experimental | Acrylic | x | ∘ | x | ∘ |
| Example 5 | | | | | |
| Experimental | Polycarbonate | x | ∘ | x | ∘ |
| Example 6 | | | | | |
| Experimental | PE | x | ∘ | x | ∘ |
| Example 7 | | | | | |
| Experimental | Unsaturated | x | ∘ | x | ∘ |
| Example 8 | polyester-based | | | | |
| | thermosetting resin | | | | |
| Experimental | Acrylic | x | ∘ | x | ∘ |
| Example 9 | thermosetting resin | | | | |
| Experimental | SUS304 | ∘ | ∘ | ∘ | ∘ |
| Example 10 | | | | | |

From the initial results in Table 3, it was confirmed that the quaternary ammonium salt-based silane coating can be applied to the various bases by using the primer. From the results after endurance shown in Table 3, it could be confirmed that the use of the primer causes the coating of even the resinous base to be maintained even after the endurance test as with the stainless base, which provides excellent durability.

### 2. Effects of Primer on Various Silane Coatings

### Experimental Examples 11 to 16

### [1] Types of Bases

As the base, a polypropylene resin (PP) was used.

### [2] Coating Treatment

A coating treatment was performed as follows.

### [2-1] Primer Preparation (Preparation of Coating Material (A))

The primer preparation is shown in Table 4. Tetrabutoxysilane and polyacrylic acid were added in this order to a predetermined amount of solvent, followed by stirring for 1 hour with a magnetic stirrer. Since a usable time after preparation was unknown, the primer was used during the day.

TABLE 4
Preparation of primer (in case of total amount of 100 g)

| | | | | | Active |
|---|---|---|---|---|---|
| | | Manufacture | Part number | Addition | ingredient |
| | Component | name | or part name | amount (g) | amount (g) |
| Component | Tetrabutoxysilane | Tokyo | T1126 | 5.00 | 5.00 |
| | | Chemical | | | |
| | | Industry | | | |
| | | Co., Ltd. | | | |
| Additive | Polyacrylic acid | Kyoeisha | Polyflow | 1.00 | 0.40 |
| | | Chemical | WS | | |
| | | Co., Ltd. | | | |
| Solvent | 1-butanol | Wako Pure | 024-03327 | 94.00 | — |
| | | Chemical | | | |
| | | Industries, | | | |
| | | Ltd. | | | |

### [2-2] Preparations of Various Silane-Based Coating Materials

The preparations of the various silane-based coating materials used are shown in Tables 5 to 7.

TABLE 5
Preparation of fluorine-based silane coating material (in case of total amount of 100 g)

| | | | | | Active |
|---|---|---|---|---|---|
| | | Manufacture | Part number | Addition | ingredient |
| | Component | name | or part name | amount (g) | amount (g) |
| Solid | Perfluoroalkyl | Shin-Etsu | X-71-107B | 5.00 | 5.00 |
| component | group- | Chemical | (3) | | |
| | containing | Co., Ltd. | | | |
| | silane | | | | |
| Catalyst | Hydrochloric | — | — | 0.10 | 3.6 × 10³ |
| | acid (1N) | | | | |
| Solvent | 1-butanol | Wako Pure | 024-03327 | 94.00 | — |
| | | Chemical | | | |
| | | Industries, | | | |
| | | Ltd. | | | |

TABLE 6
Preparation of silicone-based silane coating material
(in case of total amount of 100 g)

| | | | | | Active |
|---|---|---|---|---|---|
| | | Manufacture | Part number | Addition | ingredient |
| | Component | name | or part name | amount (g) | amount (g) |
| Solid | Both- | — | — | 5.00 | 5.00 |
| component | terminal | | | | |
| | silane | | | | |
| | modified | | | | |
| | silicone | | | | |
| Catalyst | Hydrochloric | — | — | 0.10 | 3.6 × 10³ |
| | acid (1N) | | | | |
| Solvent | 1-butanol | Wako Pure | 024-03327 | 94.00 | — |
| | | Chemical | | | |
| | | Industries, | | | |
| | | Ltd. | | | |

TABLE 7
Preparation of quaternary ammonium salt-based silane coating
(in case of total amount of 100 g)

| | | | Part | | Active |
|---|---|---|---|---|---|
| | | | number | Addition | ingredient |
| | | Manufacture | or | amount | amount |
| | Component | name | part name | (g) | (g) |
| Solid | Silane- | Microban | AEM | 4.00 | 1.60 |
| content | modified | | 5700 | | |
| | quaternary | | | | |
| | ammonium | | | | |
| | salt | | | | |
| | Trimesic | Tokyo | B0043 | 1.25 | 1.25 |
| | acid | Chemical | | | |
| | | Industry | | | |
| | | Co., Ltd. | | | |
| Solvent | Pure water | — | — | 18.95 | — |
| | 2-propanol | Wako Pure | 32435-80 | 75.80 | — |
| | (IPA) | Chemical | | | |
| | | Industries, | | | |
| | | Ltd. | | | |

### [2-3] Treatment Step (Preparation of Sample)

Treatment steps of various bases will be described below.

### Fluorine-Based Silane Coating Material

1) As shown in the above preparation Table, the fluorine-based silane coating materials were mixed, and mixed with a magnetic stirrer for 10 minutes to obtain a coating material.

2) After the PP base was immersed in IPA for 5 minutes, and dried at room temperature, the primer was wipe-applied, and then heated and cured at 60° C. for 60 minutes to obtain a primer-treated sample.

3) A fluorine-based silane coating material was wipe-applied on the sample produced in 2), and heated and cured at 60° C. for 30 minutes to obtain a fluorinated silane-treated sample.

### Silicone-Based Silane Coating Material

1) As shown in the above preparation Table, the silicone-based silane coating materials were mixed, and mixed with a magnetic stirrer for 10 minutes to obtain a coating material.

2) After the PP base was immersed in IPA for 5 minutes, and dried at room temperature, the primer was wipe-applied, and then heated and cured at 60° C. for 60 minutes to obtain a primer-treated sample.

3) A silicone-based silane coating material was wipe-applied on the sample produced in 2), and heated and cured at 60° C. for 30 minutes to obtain a silicone-based silane-treated sample.

### Quaternary Ammonium Salt-Based Silane Coating

1) As shown in the above preparation Table, IPA and trimesic acid were mixed with a magnetic stirrer until the trimesic acid was dissolved in the WA. On the other hand, a silane-modified quaternary ammonium salt and pure water were mixed with a magnetic stirrer until the silane-modified quaternary ammonium salt was dissolved in the pure water. From the two solutions thus prepared, one solution was provided, and the solution was mixed for 10 minutes to obtain a coating material.

2) After the PP base was immersed in WA for 5 minutes, and dried at room temperature, the primer was wipe-applied, and then heated and cured at 60° C. for 60 minutes to obtain a primer-treated sample.

3) A quaternary ammonium salt-based silane coating material was wipe-applied on the sample produced in 2), and heated and cured at 60° C. for 30 minutes to obtain a quaternary ammonium salt treated sample.

### [2-4] Endurance Test

Using a constant temperature water bath, the samples were immersed in water at 70° C. for 19 hours (hot water test).

### [2-5] Evaluation Method

In oil contact angle and antimicrobial tests, an initial function and a function after endurance were evaluated according to the following determination.

The antimicrobial test was based on JIS Z 2801.

(Determination)

(Oil contact angle of fluorine-based silane coating material)

◯: 60° or more

x: less than 60°

(Oil contact angle of silicone-based silane coating material)

◯: 45° or more

x: less than 45°

(Antimicrobial activity value of quaternary ammonium salt-based silane coating material)

◯: 2.0 or more

x: less than 2.0

### [2-6] Evaluation Results

The evaluation results of Experimental Examples 11 to 16 are described in Tables 8 to 9. The evaluation is as follows. Experimental Examples 11, 13, and 15 are Examples, and Experimental Examples 12, 14, and 16 are Comparative Examples.

TABLE 8

| | Types of | Presence | | | | |
|---|---|---|---|---|---|---|
| | silane- | or | Function (oil contact angle) (°) | | | |
| | based | absence | | | After | |
| | coating | of primer | Initial | Determination | endurance | Determination |
| Experimental | Fluorine- | Presence | 74 | ○ | 68 | ○ |
| Example 11 | based (oil | | | | | |
| | repellent) | | | | | |
| Experimental | Fluorine- | Absence | 22 | x | — | — |
| Example 12 | based (oil | | | | | |
| | repellent) | | | | | |
| Experimental | Silicone- | Presence | 58 | ○ | 56 | ○ |
| Example 13 | based (oil | | | | | |
| | repellent) | | | | | |
| Experimental | Silicone- | Absence | 20 | x | — | — |
| Example 14 | based (oil | | | | | |
| | repellent) | | | | | |

TABLE 9

| | Types of | Presence | | | | |
|---|---|---|---|---|---|---|
| | silane- | or | Function (antimicrobial activity value) | | | |
| | based | absence | | | After | |
| | coating | of primer | Initial | Determination | endurance | Determination |
| Experimental | Quaternary | Presence | 6.0 | ○ | 6.0 | ○ |
| Example 15 | ammonium | | | | | |
| | salt-based | | | | | |
| Experimental | Quaternary | Absence | 1.5 | x | 0.0 | x |
| Example 16 | ammonium | | | | | |
| | salt-based | | | | | |

It was confirmed that various silane-based coatings can be applied on the PP base by using the primer. These various silane-based coatings were found to have also excellent durability.

### 3. Discussion Experiment for Influence When Acid is Added to Primer Preparation

In the above Experiment Examples, the primer is composed of alkoxysilane (tetrabutoxylane) and polyacrylic acid. From various analyses, in the examples, it was found that a curing reaction (dehydration polycondensation of silanol) occurs in the primer when the quaternary ammonium salt-based silane coating material for overcoating is applied and heated. It was inferred that the curing of the primer layer may be promoted by “the acid contained in the silane-based coating for overcoating”. Therefore, here, in order to determine whether or not a problem is caused even if an acid is added not to the silane-based coating for overcoating but the primer itself, the following experiment was performed.

### [1] Test Method

A prescribed amount of the acid shown in Table 11 was added to the primer preparation of Table 10, and the state change of the primer was observed.

As the evaluation method, a method for visually observing the state change was adopted.

The evaluation is as follows.
◯=no change (transparent)
x=white turbid

TABLE 10
Preparation of primer (in case of total amount of 100 g)

| | | | | | Active |
|---|---|---|---|---|---|
| | | Manufacture | Part number | Addition | ingredient |
| | Name | name | or part name | amount (g) | amount (g) |
| Name | Tetrabutoxysilane | Tokyo | T1126 | 5.00 | 5.00 |
| | | Chemical | | | |
| | | Industry | | | |
| | | Co., Ltd. | | | |
| Additive | Polyacrylic acid | Kyoeisha | Polyflow | 1.00 | 0.40 |
| | | Chemical | WS | | |
| | | Co., Ltd. | | | |
| Acid | See Table 11 | See Table 11 | See Table 11 | See Table 11 | — |
| catalyst | | | | | |
| Solvent | 1-butanol | Wako Pure | 024-03327 | 94.00 | — |
| | | Chemical | | | |
| | | Industries, | | | |
| | | Ltd. | | | |

TABLE 11
Results obtained by adding acids to primer

| | Manufacture | Part number or | Addition | |
|---|---|---|---|---|
| Type of acids | name | part name | amount (g) | State |
| NA | — | — | — | ∘ |
| Trimesic acid | Tokyo | B0043 | 0.25 | x |
| | Chemical | | 1.25 | x |
| | Industry Co., | | 2.25 | x |
| | Ltd. | | | |
| Hydrochloric | Wako Pure | 080-01066 | 0.25 | x |
| acid | Chemical | | 1.25 | x |
| | Industries, Ltd. | | 2.25 | x |
| Sulfuric acid | Wako Pure | 192-04696 | 0.25 | x |
| | Chemical | | 1.25 | x |
| | Industries, Ltd. | | 2.25 | x |
| Citric acid | Wako Pure | 038-06925 | 0.25 | x |
| | Chemical | | 1.25 | x |
| | Industries, Ltd. | | 2.25 | x |

As shown in the results of Table 11, when the acid was added, the primer solution became white turbid. The white turbidity is inferred to be a product caused by the sedimentation or gelation or the like of the component. It was found that the addition of the acid to the primer causes the primer to become unusable.

Therefore, it was found that the acid causes the curing of the primer of the present invention to proceed, but no acid can be substantially added to the primer composition.

### 4. Influence of Acid Contained in Silane for Overcoating (Quaternary Ammonium Salt-Based Silane Coating Material) on Reaction of Primer Layer

When the coating material for a primer of the present invention was used, and a quaternary ammonium salt-based silane coating material was used for overcoating, effects provided by adding various acids to the quaternary ammonium salt-based silane coating material were confirmed.

### [1] Types of Bases

As the base, a polypropylene resin (PP) was used.

### [2] Coating Treatment

A coating treatment was performed as follows.

### [2-1] Primer Preparation (Preparation of Coating Material (A))

The primer preparation is shown in Table 12. Tetrabutoxysilane and polyacrylic acid were added in this order to a predetermined amount of solvent, followed by stirring for 1 hour with a magnetic stirrer. Since a usable time after preparation was unknown, the primer was used during the day.

TABLE 12
Preparation of primer (in case of total amount of 100 g)

| | | | | | Active |
|---|---|---|---|---|---|
| | | Manufacture | Part number | Addition | ingredient |
| | Name | name | or part name | amount (g) | amount (g) |
| Name | Tetrabutoxysilane | Tokyo | T1126 | 5.00 | 5.00 |
| | | Chemical | | | |
| | | Industry | | | |
| | | Co., Ltd. | | | |
| Additive | Polyacrylic acid | Kyoeisha | Polyflow | 1.00 | 0.40 |
| | | Chemical | WS | | |
| | | Co., Ltd. | | | |
| Solvent | 1-butanol | Wako Pure | 024-03327 | 94.00 | — |
| | | Chemical | | | |
| | | Industries, | | | |
| | | Ltd. | | | |

### [2-2] Preparation of Quaternary Ammonium Salt-Based Silane Coating Material

The preparation of the silane-based coating material used is shown in Table 13. Here, trimesic acid, hydrochloric acid, sulfuric acid, and citric acid were used.

TABLE 13
Preparation of quaternary ammonium salt-based silane coating

| | | | Part | | Active |
|---|---|---|---|---|---|
| | | | number | Addition | ingredient |
| | | Manufacture | or | amount | amount |
| | Name | name | part name | (g) | (g) |
| Solid | Silane- | Microban | AEM | 4.00 | 1.60 |
| content | modified | | 5700 | | |
| | quaternary | | | | |
| | ammonium | | | | |
| | salt | | | | |
| | Acid | See Table 14 | See | See | — |
| | | | Table 14 | Table 14 | |
| Solvent | Pure water | — | — | 18.95 | — |
| | IPA (2- | Wako Pure | 32435-80 | 75.80 | — |
| | propanol) | Chemical | | | |
| | | Industries, | | | |
| | | Ltd. | | | |

### [2-3] Treatment Step (Preparation of Sample)

The treatment step of the base is shown below.

1) As shown in the above preparation Table, IPA and a predetermined acid were mixed with a magnetic stirrer until the acid was dissolved in the IPA. On the other hand, a silane-modified quaternary ammonium salt and pure water were mixed with a magnetic stirrer until the msilane-odified quaternary ammonium salt was dissolved in the pure water. They were mixed. They were mixed with a magnetic stirrer for 10 minutes to obtain a quaternary ammonium salt-based silane coating material.

2) After the PP base was immersed in IPA for 5 minutes, and dried at room temperature, the primer was wipe-applied, and then heated and cured at 60° C. for 60 minutes to obtain a primer-treated sample.

3) A quaternary ammonium salt-based silane coating material was wipe-applied on the sample produced in 2), and heated and cured at 60° C. for 30 minutes to obtain a quaternary ammonium salt treated sample.

### [2-4] Endurance Test

Using a constant temperature water bath, the samples were immersed in water at 70° C. for 19 hours (hot water test).

### [2-5] Evaluation Method

The BPB solution was dropped onto the sample, and the wettability of the appearance was visually determined. A coating for suppressing slime deposition is colored by the BPB solution.

◯=good wetting

x=poor wetting

### [2-6] Evaluation Results

The results are shown in Table 14. Experimental Examples 17 to 29 are Examples of the present invention.

TABLE 14
Effects of acids added to quaternary ammonium
salt-based silane coating material

| | | | | Endurance (hot |
|---|---|---|---|---|
| | Type of acids | Addition ratio | Initial | water) |
| Experimental | Trimesic acid | 0.00% | ∘ | x |
| Example 17 | | | | |
| Experimental | Trimesic acid | 0.10% | ∘ | ∘ |
| Example 18 | | | | |
| Experimental | Trimesic acid | 0.25% | ∘ | ∘ |
| Example 19 | | | | |
| Experimental | Trimesic acid | 1.25% | ∘ | ∘ |
| Example 20 | | | | |
| Experimental | Hydrochloric | 0.25% | ∘ | ∘ |
| Example 21 | acid | | | |
| Experimental | Hydrochloric | 1.25% | ∘ | ∘ |
| Example 22 | acid | | | |
| Experimental | Hydrochloric | 2.25% | ∘ | ∘ |
| Example 23 | acid | | | |
| Experimental | Sulfuric acid | 0.25% | ∘ | ∘ |
| Example 24 | | | | |
| Experimental | Sulfuric acid | 1.25% | ∘ | ∘ |
| Example 25 | | | | |
| Experimental | Sulfuric acid | 2.25% | ∘ | ∘ |
| Example 26 | | | | |
| Experimental | Citric acid | 0.25% | ∘ | ∘ |
| Example 27 | | | | |
| Experimental | Citric acid | 1.25% | ∘ | ∘ |
| Example 28 | | | | |
| Experimental | Citric acid | 2.25% | ∘ | ∘ |
| Example 29 | | | | |

From the results in Table 14, the initial function and the function after the endurance test could be secured even if the organic acid or the inorganic acid was added. Because of the durability, even an acid other than trimesic acid is inferred to provide an effect of promoting the curing of the primer.

Even if the acid was not added, the quaternary ammonium salt-based silane coating was satisfactorily fixed on the base at the initial stage.

### 5. Endurance Test of Resin-Treated Article Treated With Quaternary Ammonium Salt-Based Silane Coating Material

A resin-treated article was produced by using the coating material for the primer of the present invention and using the quaternary ammonium salt-based silane coating material for overcoating. The resin-treated article was subjected to an endurance test.

### [1] Production of Resin-Treated Article

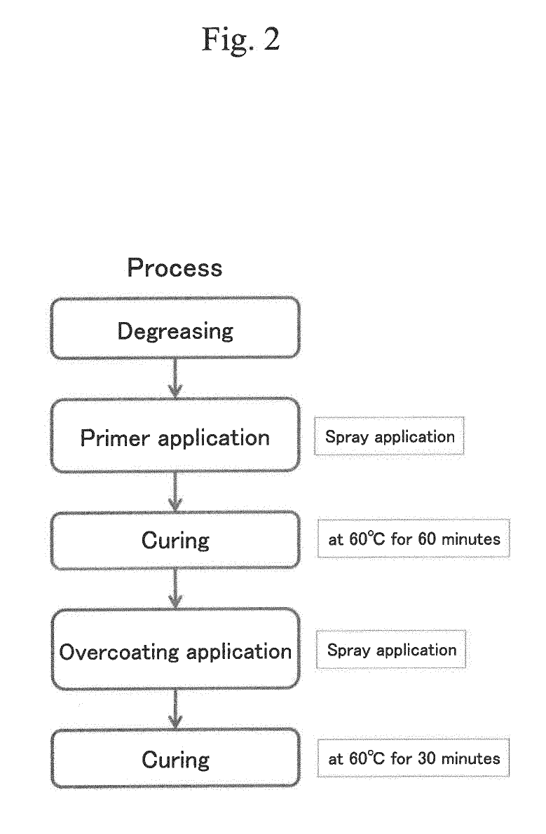

The resin-treated article was produced according to the process shown in FIG. 2. The specific procedure will be shown below.

### [1-1] Preparation of Base

A flat plate (50 mm×50 mm×50 mm, t=3 mm, PP base) produced by injection molding and made of a polypropylene resin was used as a base.

### [1-2] Degreasing

The base was immersed in IPA (2-propanol) for 5 minutes and degreased.

### [1-3] Primer Treatment

The primer was prepared so as to have formulations shown in Table 15. Specifically, 2 g of polyacrylic acid (Polyflow WS, Kyoeisha Chemical Co., Ltd.) and 10 g of tetrabutoxysilane (Tokyo Chemical Industry Co., Ltd.) were mixed in this order with 188 g of 1-butanol (Wako Pure Chemical Industries, Ltd.), followed by stirring with a magnetic stirrer at 600 rpm for 60 minutes, to prepare the primer.

TABLE 15
Preparation of primer (in case of total amount of 200 g)

| | | | | | Active |
|---|---|---|---|---|---|
| | | Manufacture | Part number | Addition | ingredient |
| | Name | name | or part name | amount (g) | amount (g) |
| Name | Tetrabutoxysilane | Tokyo | T1126 | 5.00 | 5.00 |
| | | Chemical | | | |
| | | Industry | | | |
| | | Co., Ltd. | | | |
| Additive | Polyacrylic acid | Kyoeisha | Polyflow | 1.00 | 0.40 |
| | | Chemical | WS | | |
| | | Co., Ltd. | | | |
| Solvent | 1-butanol | Wako Pure | 024-03327 | 94.00 | — |
| | | Chemical | | | |
| | | Industries, | | | |
| | | Ltd. | | | |

The primer was spray-applied on the PP base. The application amount was adjusted to 10 g/m² in WET. After the primer was set for 5 minutes, the primer was heated in a dryer at 60° C. for 60 minutes.

### [1-4] Quaternary Ammonium Salt-Based Silane Coating Treatment

Silane-based coating materials were prepared so as to have formulations shown in Table 16. Specifically, 75.80 g of IPA (Wako Pure Chemical Industries, Ltd.) and 15.16 g of pure water were mixed, followed by thoroughly stirring with a magnetic stirrer. Then, 1.25 g of trimesic acid (Tokyo Chemical Industry Co., Ltd.) was added thereto, followed by stirring until the trimesic acid was completely dissolved.

4.00 g of a silane-modified quaternary ammonium salt (trade name: AEM 5700 manufactured by Microban) and 3.79 g of pure water were mixed, followed by stirring with a magnetic stirrer. The two solutions were mixed, followed by stirring with a magnetic stirrer for 60 minutes to prepare a quaternary ammonium salt-based silane coating material.

TABLE 16
Preparation of Quaternary Ammonium Salt-Based Silane Coating

| | | | Part | | Active |
|---|---|---|---|---|---|
| | | | number | Addition | ingredient |
| | | Manufacture | or | amount | amount |
| | Name | name | part name | (g) | (g) |
| Solid | Silane- | Microban | AEM | 4.00 | 1.60 |
| content | modified | | 5700 | | |
| | quaternary | | | | |
| | ammonium | | | | |
| | salt | | | | |
| | Trimesic | Tokyo | — | 1.25 | 1.25 |
| | acid | Chemical | | | |
| | | Industry | | | |
| | | Co., Ltd. | | | |
| Solvent | Pure water | — | — | 18.95 | — |
| | IPA (2- | Wako Pure | 32435-80 | 75.80 | — |
| | propanol) | Chemical | | | |
| | | Industries, | | | |
| | | Ltd. | | | |

| | | |
|---|---|---|
| Total | 100.00 | 2.85 |

The quaternary ammonium salt-based silane coating was spray-applied to the primer-treated PP base. The application amount was adjusted to 60 g/m² in WET. After the primer was set for 5 minutes, the primer was heated in a dryer at 60° C. for 30 minutes to obtain a PP sample treated with a quaternary ammonium salt.

### [2] Endurance Test

The PP sample treated with the quaternary ammonium salt was subjected to an endurance test.

The substantivities of the initial function and function after the endurance test were evaluated based on the antimicrobial activity value of the antimicrobial test.

The evaluation was performed as follows.

The antimicrobial test was executed using Bacillus coli according to the antimicrobial test JIS Z 2801.

In the antimicrobial test, the antimicrobial activity value of 2.0 or more was determined as sustained antimicrobial properties.

The function after the endurance test was evaluated by measuring the antimicrobial activity value after performing the following various tests.

### <1> Hot Water Test

<1-1> The PP sample was immersed in warm water at 70° C. for 200 hours.

<1-2> The PP sample was immersed in warm water at 70° C. for 500 hours.

### <2> Thermal Cycle

The PP sample was subjected to a temperature change of 20 cycles at −20° C. ←→60° C.

### <3> Heat Shock

The PP sample was cooled to −20° C., and then hot water of 80° C. was applied thereto. This was repeated ten times.

### <4> High Temperature Leaving Test

The PP sample was left to stand at 60° C. for 168 hours.

### <5> Low Temperature Leaving Test

The PP sample was left to stand at −30° C. for 24 hours.

### <6> Detergent Resistance Test

<6-1> The PP sample was immersed in a shampoo undiluted solution (trade name: LUX Super Rich manufactured by Unilever) for 24 hours.

<6-2> The PP sample was immersed in a hair conditioner undiluted solution (trade name: LUX Super Rich manufactured by Unilever) for 24 hours.

<6-3> The PP sample was immersed in a body soap undiluted solution (trade name: Biore U manufactured by Kao Corporation) for 24 hours.

<6-4> A hair coloring agent (trade name: Bigen manufactured by Hoyu Co., Ltd.) was applied to the PP sample, followed by leaving to stand for 24 hours.

<6-5> The PP sample was immersed in a sodium hypochlorite detergent (trade name: Pipe Unish manufactured by Johnson Company Limited) for 2 hours.

<6-6> A mold remover (trade name: Kabikiller manufactured by Johnson Company Limited) was applied to the PP sample, followed by leaving to stand for 2 hours.

<6-7> A bathroom detergent undiluted solution (trade name: Bath Magiclean manufactured by Kao Corporation) was applied to the PP sample, followed by leaving stand for 24 hours.

<6-8> The PP sample was immersed in a bleaching agent undiluted solution (trade name: WideHighter manufactured by Kao Corporation) for 24 hours.

<6-9> The PP sample was immersed in a household detergent undiluted solution (trade name: Kantanmypet manufactured by Kao Corporation) for 24 hours.

<6-10> The PP sample was immersed in a glass detergent (trade name: Glass Magiclean manufactured by Kao Corporation) for 24 hours.

<6-11> The PP sample was immersed in a 10% bath agent aqueous solution (trade name: Bab manufactured by Kao Corporation) for 24 hours.

### <7> Chemical Resistance Test

<7-1> The PP sample was immersed in 3% hydrochloric acid (40° C.) for 24 hours.

<7-2> The PP sample was immersed in 10% salt water for 24 hours.

<7-3> The PP sample was immersed in 10% aqueous ammonia for 24 hours.

<7-4> The PP sample was immersed in machine oil for 24 hours.

### <8> Abrasion Resistance Test

The PP sample was subjected to reciprocating friction using a sponge 15000 times in a wet manner under a load of 100 kg/m².

### [3] Results of Endurance Test

The results of the endurance test are described in Tables 17 and 18.

TABLE 17

| | | Antimicrobial | |
|---|---|---|---|
| Item | Method | activity value | (Supplement) |
| Initial state | Treated PP | 6.1 | |
| | Untreated PP | 0.0 | |
| Hot Water Test | Immersed in hot water at | 6.1 | |
| | 70° C. for 200 h | | |
| | Immersed in hot water at | 6.1 | |
| | 70° C. for 500 h | | |
| Thermal Cycle | −20° C. ⇔ 60° C., 20 cycles | 6.1 | |
| Heat Shock | −20° C. ⇔ 80° C., hot water, | 6.1 | |
| | 10 times | | |
| High Temperature | 60° C. 168 h | 6.1 | |
| Leaving Test | | | |
| Low temperature | −30° C. 24 h | 6.1 | |
| leaving test | | | |
| Detergent | Shampoo undiluted | 6.1 | LUX Super Rich |
| Resistance Test | solution, 24 h | | |
| | Conditioner undiluted | 6.1 | LUX Super Rich |
| | solution, 24 h | | |
| | Body soap undiluted | 6.1 | Biore U |
| | solution, 24 h | | |
| | Application of hairdye, 24 h | 6.1 | Bigen |
| | Immersed in sodium | 6.1 | Pipe Unish |
| | hypochlorite detergent for | | |
| | 2 h | | |
| | Application of mold | 6.1 | Kabikiller |
| | remover, 2 h | | |
| | Application of bathroom | 6.0 | Bath Magiclean |
| | detergent undiluted | | |
| | solution, 24 h | | |
| | Bleach undiluted solution, | 3.6 | WideHighter |
| | 24 h | | |
| | Household detergent | 6.1 | Kantanmypet |
| | undiluted solution, 24 h | | |
| | Glass cleaner undiluted | 6.1 | Glass Magiclean |
| | solution, 24 h | | |
| | 10% bath agent aqueous | 6.1 | Bab |
| | solution | | |

TABLE 18

| | | Antimicrobial |
|---|---|---|
| | | activity |
| Item | Method | value |
| Chemical | immersed in 3% hydrochloric acid at | 6.1 |
| Resistance | 40° C. for 24 h | |
| Test | immersed in 10% salt water for 24 h | 6.1 |
| | immersed in 10% aqueous ammonia for | 6.1 |
| | 24 h | |
| | immersed in machine oil for 24 h | 6.1 |
| Friction | Sponge friction, | 6.1 |
| resistance test | under load of 100 kg/m², in wet | |
| | manner, reciprocating friction 15000 | |
| | times | |

Even after all the executed endurance tests, the antimicrobial activity value of 2.0 or more was maintained. In particular, the initial antimicrobial activity value of 6.1 (upper limit in the test) was maintained even after most endurance tests. Therefore, presence of very excellent durability was found. Thus, it could be confirmed that the use of the primer even in the PP sample causes the antimicrobial coating to be maintained even after the endurance test, and the PP sample has excellent durability.

### 6. Actual Exposure Test of Hair Catcher Treated With Quaternary Ammonium Salt-Based Silane Coating Material

A hair catcher treated with the quaternary ammonium salt-based silane coating material was produced by using the coating material for a primer of the present invention and using the quaternary ammonium salt-based silane coating material for overcoating. The effect of the actual exposure of the hair catcher thus treated was confirmed.

### [1] Production of Hair Catcher Treated With Quaternary Ammonium Salt-Based Silane Coating Material

A hair catcher was produced in accordance with the process shown in FIG. 2 in the same manner as in the above “5. Endurance Test Of Resin-Treated Article Treated With Quaternary Ammonium Salt-Based Silane Coating Material”.

As a base, bathroom hair catchers (model numbers: TS-M(9)-K, TS-M(12) manufactured by LIXIL Corporation) were used. Both the bathroom hair catchers are made of polypropylene resin.

The bathroom hair catchers were subjected to a primer treatment and a quaternary ammonium salt-based silane coating treatment in the same manner as in the above “5. Endurance Test Of Resin-Treated Article Treated With Quaternary Ammonium Salt-Based Silane Coating Material”.

### [2] Exposure Test

When the hair catcher treated with the quaternary ammonium salt-based silane coating material was applied to a bathroom drain port, the hair catcher was exposed to an actual use environment to perform the test.

The application of the hair catcher thus treated to the bathroom drain port has the following significance. That is, in the bathroom drain port, slime deposition is apt to occur, which makes it necessary to frequently clean the bathroom drain port. The slime deposition is unsanitary in appearance, which disadvantageously gives discomfort to the user. The slime deposition is produced by the activity of bacteria, so that the use of a quaternary ammonium salt having high antimicrobial properties in the drain port can be expected to provide an effect of suppressing the slime deposition.

On the other hand, many resin products are used for the hair catcher installed in the drain port, so that the quaternary ammonium salt is fixed on the surface of the resin hair catcher by using the primer of the present invention and the quaternary ammonium salt-based silane coating material, which provides the suppression of the slime deposition. Thus, the cleanliness can be effectively maintained by taking measures of suppressing slime deposition on both the drain port and the hair catcher.

### Test Method

The hair catcher treated as described above was installed in a general household bathroom drain port. After one month elapsed, the effect of suppressing slime deposition was evaluated (sixteen treated articles were evaluated (N=16)). As Reference Example, an untreated PP catcher was also tested (twenty untreated articles were evaluated (N=20)). As a determination method, the occurrence state of slime deposition was visually confirmed, and determined by three or more testers. Specifically, the scores were shown in the following Table, and the case where the score was 2 or less provided an effect of suppressing slime deposition, and was determined as pass.

TABLE 19

| State (visually determined | | | Pass/ |
|---|---|---|---|
| by 3 or more testers) | Score | Determination | fail |
| Almost no slime deposition adheres | 1 | Effect of | Pass |
| | | suppressing slime | |
| | | deposition | |
| Very thin slime deposition partially | 2 | Effect of | Pass |
| adheres | | suppressing slime | |
| | | deposition | |
| Firm slime deposition partially adheres | 3 | No effect of | Fail |
| | | suppressing slime | |
| | | deposition | |
| Firm slime deposition adheres not | 4 | No effect of | Fail |
| completely but widely | | suppressing slime | |
| | | deposition | |
| Firm slime deposition completely | 5 | No effect of | Fail |
| adheres | | suppressing slime | |
| | | deposition | |

### [3] Results of Actual Exposure Test

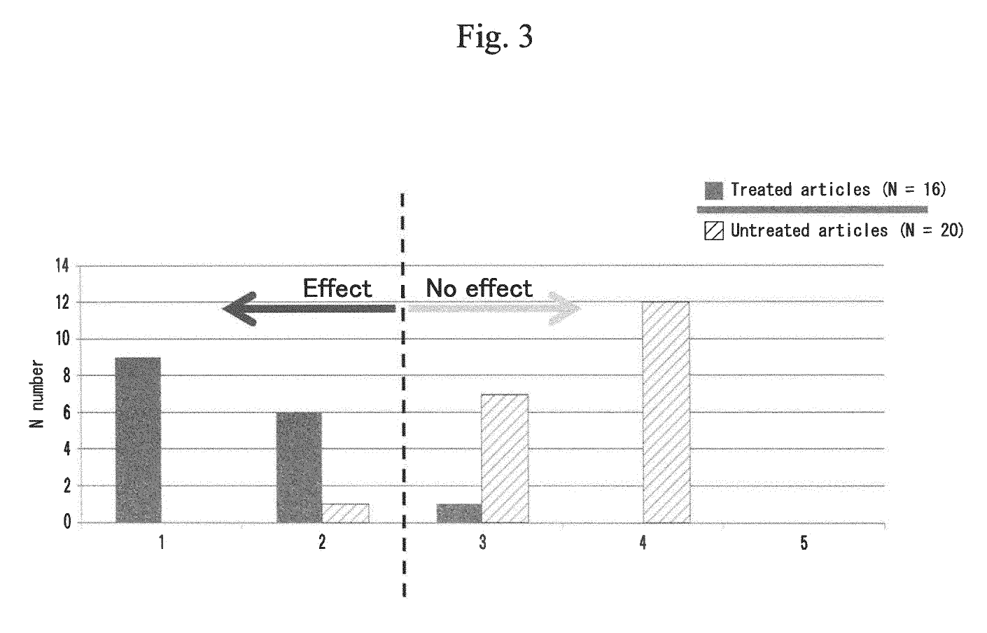

The results of the actual exposure test are described in Table 20 and FIG. 3.

TABLE 20
Results of actual exposure test

| | | | | Untreated article |
|---|---|---|---|---|
| | | | Treated article | (Reference |
| Score | Effect | Pass/fail | (Examples) N = 16 | Examples) N = 20 |
| 1 | Effective | Pass | 9 | 0 |
| 2 | Effective | Pass | 6 | 1 |
| 3 | Ineffective | Fail | 1 | 7 |
| 4 | Ineffective | Fail | 0 | 12 |
| 5 | Ineffective | Fail | 0 | 0 |

From the results in Table 20 and FIG. 3, the effect was confirmed in 94% ( 15/16) of the treated articles (Examples) and 5% ( 1/20) of the untreated articles (Reference Examples). On the other hand, the effect was not confirmed, which caused the adhesion of slime deposition, in 6% ( 1/16) of the treated articles (Examples) and 95% ( 19/20) of the untreated articles (Reference Examples).

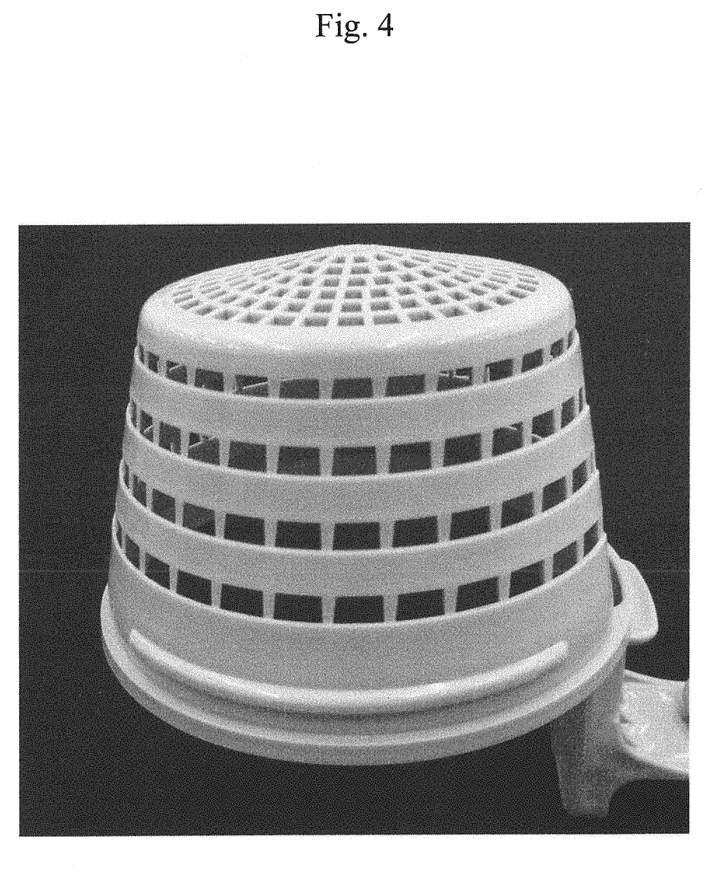

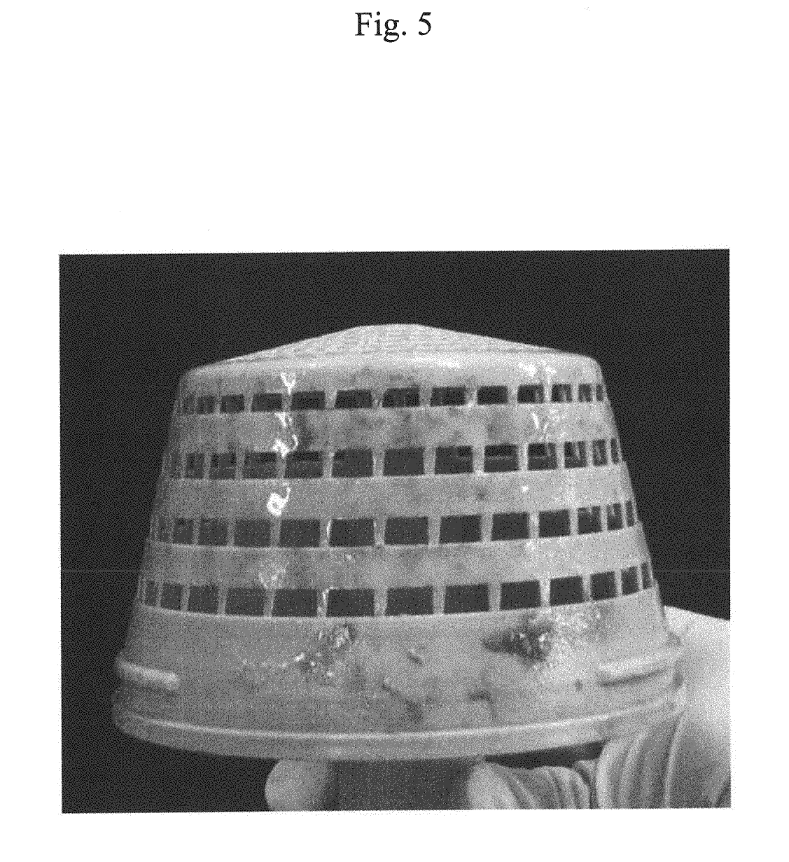

Here, FIG. 4 shows a photograph of one of Examples which has the score of “1” and is evaluated as “almost no slime deposition adheres”. As shown in the photograph, slime deposition cannot be visually confirmed. FIG. 5 shows a photograph of one of Reference Examples which has the score of “3” and is evaluated as “firm slime deposition partially adheres”. As shown in the photograph, slime deposition was visually confirmed.

It was confirmed that, in one of the treated articles (Examples) where slime deposition occurs, the antimicrobial coating film is maintained after the slime deposition is removed, and the result does not deny the effect of the present invention.

As in the various tests described above, it was confirmed that the quaternary ammonium salt-based silane coating can be applied to the resinous base by using the primer of the present invention. It could be confirmed that the coating is maintained even after the endurance test by using the primer for even the resinous base as with the stainless steel base, which provides excellent durability. It was confirmed that the present invention is suitably applied to the resin hair catcher installed in the bathroom drain port, which provides a very high effect of suppressing slime deposition.

The present invention is not limited to Examples described by the above description and drawings.

### INDUSTRIAL APPLICABILITY

The present invention can be widely applied to members equipped to a place around water supply and drainage such as a bathroom hair catcher, a bathroom floor of a unit bath or the like, a drain trap and drain plate of the bathroom floor, a drain tap of a bathtub, a drain trap of a sink of a system kitchen or the like, a drain waste basket, a drain plate, a washbowl of a bathroom vanity, a drain trap of the washbowl, and a drain plug.

1. A coating material for a primer which fixes a silane-based coating on a resinous base,
the coating material comprising:
a polymer (A-1) having a repeating unit represented by the following formula (1); and
an alkoxysilane having two or more alkoxy groups in its molecule and/or a hydrolysis product (A-2) thereof. 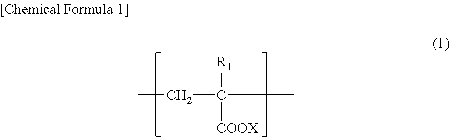
wherein R¹ represents a hydrogen atom or a methyl group, and X represents a hydrogen atom, Na, or K.

2. A coating material set comprising:
the coating material (A) according to claim 1; and
a coating material (B) containing a quaternary ammonium salt represented by the following formula (2) and/or a hydrolysis product (B-1) thereof. 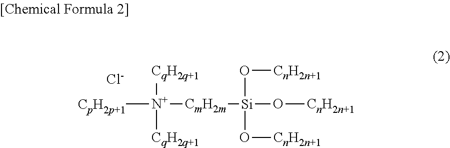
wherein: n represents an integer of 1 to 4; in represents an integer of 1 to 10; p represents an integer of 10 to 22; and q represents an integer of 1 to 3.

3. The coating material set according to claim 2, wherein the coating material (B) contains an organic acid or an inorganic acid.

4. The coating material set according to claim 2, wherein the coating material set is used for antimicrobial coating.

5. The coating material set according to claim 2, wherein the resinous base is at least one selected from the group consisting of a polypropylene resin, an ABS resin, a POM resin, a vinyl chloride resin, an acrylic resin, a polycarbonate resin, a polyethylene resin, an unsaturated polyester-based thermosetting resin, and an acrylic thermosetting resin.

6. The coating material set according to claim 2, wherein the alkoxysilane and/or the hydrolysis product (A-2) thereof have/has four functional groups.

7. A plumbing member coated with the coating material set according to claim 2.
